(19) United States
(12) Patent Application Publication
(10) Pub. No.: US 2023/0364981 A1
(43) Pub. Date: Nov. 16, 2023

(54) CHASSIS-INTEGRATED HIGH-VOLTAGE BATTERY THERMAL MANAGEMENT SYSTEM

(71) Applicant: Aikar Technology Inc., Torrance, CA (US)

(72) Inventors: Jiannan TAN, Irvine, CA (US); Tianxin NIE, Rancho Palos Verdes, CA (US)

(21) Appl. No.: 18/196,559

(22) Filed: May 12, 2023

Related U.S. Application Data
(60) Provisional application No. 63/341,322, filed on May 12, 2022.

(51) Int. Cl. B60K 11/02; B60L 50/64; B60K 1/04; H01M 50/213; H01M 10/6552; H01M 10/6551; H01M 10/6554; H01M 10/6563; H01M 10/625; H01M 10/6571

(52) U.S. Cl. CPC B60K 11/02; B60L 50/64; B60K 1/04; H01M 50/213; H01M 10/6552; H01M 10/6551; H01M 10/6554; H01M 10/6563; H01M 10/625; H01M 10/6571; B60K 2001/005

(57) ABSTRACT

A thermal system for a battery pack comprising a plurality of battery cells, the battery pack integrated in a chassis of a vehicle, the thermal system including: one or more unidirectional heat pipes each positioned in contact with one or more of the plurality of battery cells and configured to spread heat from the one or more battery cells to the chassis of the vehicle; and a plurality of cooling fins located on the chassis of the vehicle and configured to sink heat from chassis into ambient.

### CROSS REFERENCE TO RELATED APPLICATIONS

The application claims the benefit of U.S. Provisional Application Ser. No. 63/341,322, filed on May 12, 2022, the disclosure of which is hereby incorporated by reference in its entirety.

### FIELD

This relates generally to vehicle battery thermal systems and methods, and more particularly, to a chassis-integrated high-voltage (HV) battery thermal management system.

### BACKGROUND

Hybrid vehicles including hybrid plug-in vehicles and electric vehicles (collectively as “EVs”) are gaining popularity. These types of vehicles typically include one or more batteries. The batteries can be high voltage batteries that can be the main or secondary power source of the vehicle. For the batteries to operate normally, proper cooling and/or heating is needed. Many existing EVs use liquid cooling for their batteries. These liquid cooling systems require extra space in the battery pack and are often difficult to manufacture due to their complexity.

### SUMMARY

This disclosure relates vehicle battery thermal systems and methods. Specifically, embodiments of the disclosure are directed to a chassis-integrated HV battery thermal management system. The disclosure system can utilize heat pipes to reduce the number of cooling tubes typically required for a liquid-cooled battery. In addition, by being integrated in the chassis of the vehicle, embodiments of the battery thermal system can eliminate some of the common components in existing thermal management systems, thereby reducing the battery pack's overall footprint in the vehicle.

### BRIEF DESCRIPTION OF THE DRAWINGS

FIG. 1 is a block diagram illustrating the exemplary components of a chassis-integrated HV battery thermal management system, according to an embodiment of the present disclosure.

FIG. 2 provides a top-down view of a section of the battery pack, showing a unidirectional heat pipes placed among multiple battery cells, according to an embodiment of the present disclosure.

### DETAILED DESCRIPTION OF THE PREFERRED EMBODIMENTS

In the following description of preferred embodiments, reference is made to the accompanying drawings which form a part hereof, and in which it is shown by way of illustration specific embodiments, which can be practiced. It is to be understood that other embodiments can be used and structural changes can be made without departing from the scope of the embodiments of this disclosure.

It is contemplated that the embodiments of the chassis-integrated HV battery thermal management system disclosed herein can be incorporated into any vehicle that uses a HV battery. The vehicle may be an electric vehicle, a fuel cell vehicle, a hybrid vehicle, a hybrid plug-in vehicle, or any other types of vehicle (generally referred to hereinafter as “EV”) that utilizes one or more HV batteries as its power source. The vehicle may have any body style, such as a sports car, a coupe, a sedan, a pick-up truck, a station wagon, a sports utility vehicle (SUV), a minivan, or a conversion van. The vehicle may include at least one battery pack (or “battery”) that serves as the energy source of the vehicle. The battery pack can include one or more batteries cells. The battery pack can be a high voltage battery or any other type of battery suitable for use in a vehicle. Most if not all EV battery packs generally need to operate within a specific temperature range. When the temperature is too high or too low, the battery pack may not function properly and may even become a safety hazard in extreme cases. As such, maintaining the temperature of the battery within the desired range is critical.

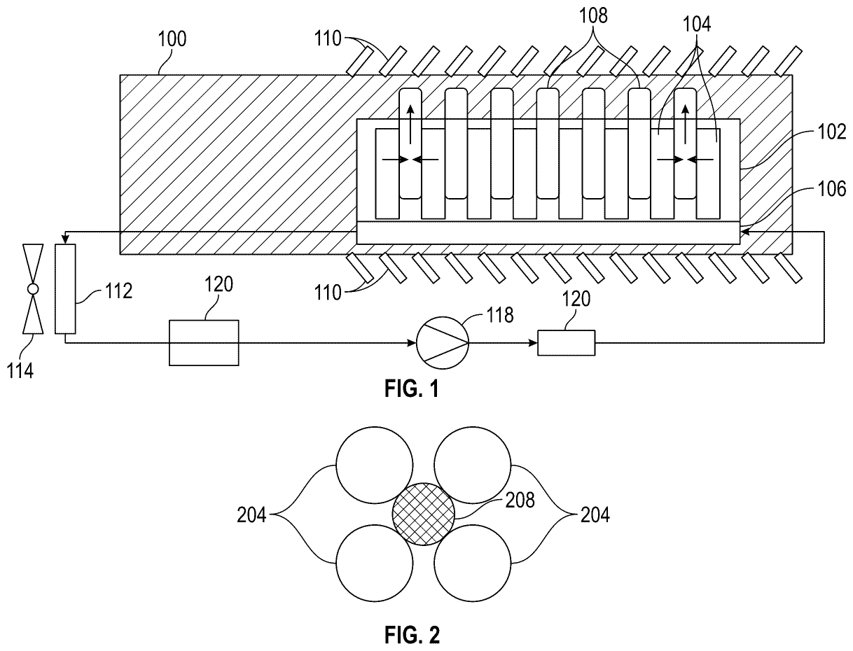

In general, this disclosure relates to a chassis-integrated HV battery thermal management system for an EV. In the disclosed system, the battery chamber and battery cooling plate are both integrated into the chassis of the vehicle. Unidirectional heat pipes are embordered in chassis spreading heat from battery cells to the chassis. Cooling fins are located on certain areas of the chassis surface to sink heat quickly from chassis into ambient. An exemplary embodiment is discussed in detail below with referenced to FIGS. 1 and 2.

FIG. 1 illustrates a chassis-integrated HV battery thermal management system. The battery pack 102 can include multiple battery cells (collectively 104). The battery cells can be cylindrical cells or cells or other shapes. The battery pack 102 is integrated as part of the chassis 100. In other words, the battery cells 104 will be a party of the vehicle chassis 100. This is done to reduce the number of parts and mass of the battery pack. The battery pack 102 can include a cooling system that is designed to keep the battery cells 104 from overheating when in use.

As illustrated in FIG. 1, the cooling system can include a chassis-integrated coolant cooling plate 106, unidirectional heat pipes (collectively 108), cooling fins (collectively 110), radiator 112, fan 114, coolant pump 116, coolant reservoir 120, and positive temperature coefficient (PTC) heater 118. The coolant reservoir 120, coolant pump 118, the PTC heater 120, chassis-integrated coolant cooling plate 106, and radiator 112 are in fluid communication with each other. In operation, the coolant pump 118 pumps coolant (e.g., water or other liquid coolant) from the coolant reservoir 120 into the chassis-integrated coolant cooling plate 118. The coolant is kept at a constant temperature by the PTC heater 120. Once in the chassis-integrated coolant cooling plate 106, the coolant cooling plate 106 can lower the temperature of the battery pack 102 through heat transfer from the battery cells 104 to the coolant. It should be noted that the chassis-integrated coolant cooling plate 106 is integrated into the vehicle chassis in a similar fashion as the battery pack 102.

The coolant is then circulated from the chassis-integrated coolant cooling plate 106 to the radiator 112, which, with the help of fan 114, can dissipate heat from the coolant exit from the coolant cooling plate 106.

In the embodiment illustrated in FIG. 1, a second cooling path is shown through the use of the unidirectional heat pipes 108 and chassis-mounted cooling fins 110. One or more of the heat pipes 108 can be positioned among the battery cells 104. For example, a heat pipe 208 can be cylindrical and placed among four battery cells 204 as shown in the top-down view illustrated in FIG. 2. It should be understood that the heat pipes 108 can be of any shape and size and placed in different patterns than the one shown in the figures. Preferably, the placement of the heat pipes 108 in the battery pack 102 enables cooling of all battery cells 104 in the pack 102.

The unidirectional heat pipes 108 can direct heat from the battery cells 104 to the chassis of the vehicle 100. This is possible because the battery pack 102 is a part of the chassis 100. Because the chassis 100 is made of metal components, it can serve as a heat conducting medium to dissipate heat from the unidirectional heat pipes 108. Cooling fins 110 can be incorporated in the chassis to enhance the surface area for heat transfer away from the heat pipes 108. Any number of cooling fins 110 can be used. The number and placement of the cooling fins 110 can be determined by the design and cooling needs of the battery pack 102.

Because of the incorporation of the unidirectional heat pipes 108 in the disclosed battery cooling system of FIG. 1, coolant-based cooling (e.g., chassis-integrated coolant cooling plate and other components used in circulating the coolant) can be significantly reduced or even eliminated in some of the embodiments. This would simplify manufacturing process and reduce cost of the overall chassis-integrated battery pack 102.

Although embodiments of this disclosure have been fully described with reference to the accompanying drawings, it is to be noted that various changes and modifications will become apparent to those skilled in the art. Such changes and modifications are to be understood as being included within the scope of embodiments of this disclosure as defined by the appended claims.

What is claimed is:

1. A thermal system for a battery pack comprising a plurality of battery cells, the battery pack integrated in a chassis of a vehicle, the thermal system comprising:
one or more unidirectional heat pipes each positioned in contact with one or more of the plurality of battery cells and configured to spread heat from the one or more battery cells to the chassis of the vehicle; and
a plurality of cooling fins located on the chassis of the vehicle and configured to sink heat from chassis into ambient.

2. The thermal system of claim 1, further comprising a coolant cooling plate integrated in the chassis of the vehicle and configured to provide liquid cooling to the plurality of battery cells.

3. The thermal system of claim 1, further comprising a cooling pump, a PTC heater, a radiator, and a fan.

4. A vehicle comprising:
a chassis;
a battery pack comprising a plurality of battery cells, the battery pack integrated in the chassis of a vehicle; and
a thermal system configured to cool the plurality of battery cells, the thermal system comprising:
one or more unidirectional heat pipes each positioned in contact with one or more of the plurality of battery cells and configured to spread heat from the one or more battery cells to the chassis of the vehicle; and
a plurality of cooling fins located on the chassis of the vehicle and configured to sink heat from chassis into ambient.

5. The thermal system of claim 4, wherein the thermal system further comprises a coolant cooling plate integrated in the chassis of the vehicle and configured to provide liquid cooling to the plurality of battery cells.

6. The thermal system of claim 4, wherein the thermal system further comprises a cooling pump, a PTC heater, a radiator, and a fan.
